(19) United States
(12) Patent Application Publication
(10) Pub. No.: US 2025/0053439 A1
(43) Pub. Date: Feb. 13, 2025

(54) Horizontally Scaling Monolithic Applications with Intelligent Transaction Routing

(71) Applicant: International Business Machines Corporation, Armonk, NY (US)

(72) Inventors: Visarut Asvaraksh, Bangkok (TH); Arup Laha, Kolkata (IN); Abdul Ahad, Bangkok (TH)

(21) Appl. No.: 18/231,392

(22) Filed: Aug. 8, 2023

(51) Int. Cl. G06F 9/46; G06F 9/30; G06F 9/54

(52) U.S. Cl. CPC G06F 9/467; G06F 9/3004; G06F 9/541

(57) ABSTRACT

Mechanisms are provided for routing transactions to backend application instances. The mechanisms receive a transaction from a source computing system, wherein the transaction comprises at least one identifier of a product or service associated with the transaction. The mechanisms perform a lookup operation in an in-memory database of transaction routing information, based on the at least one identifier. The transaction routing information maps the at least one identifier to a backend application instance identifier of a backend application instance. The mechanisms route the transaction to the backend application instance based on the backend application instance identifier, process, by the backend application instance, the transaction to generate transaction results, and return the transaction results to the source computing system.

### BACKGROUND

The present application relates generally to an improved data processing apparatus and method and more specifically to an improved computing tool and improved computing tool operations/functionality for performing horizontal scaling of monolithic applications using intelligent transaction routing.

Application scaling refers to the ability of an application to handle increased loads without affecting the user experience negatively. Application scalability involves the application being able to add additional resources, such as servers, databases, network bandwidth, and the like, in response to increased demands so as to accommodate growth. For example, as more users start to utilize an application, the demands for the application resources increase and must be accommodated by scaling the application to meet the increased demands and thereby continue to function correctly under increased workload and user base.

Application scalability may be performed vertically and/or horizontally. Vertical scalability, or “scaling up”, refers to scaling the application by increasing the capacity of a single computing system by adding more resources allocated to the application, e.g., memory, storage, or the like, so as to increase the throughput of the computing system. With vertical scaling, no new resources are added, but instead the capabilities of the existing resources are made more efficient. Vertical scaling has relatively lower costs and is easier to implement than horizontal scaling, but also presents a single point of failure.

Horizontal scaling, or a scale-out approach, on the other hand, involves adding more instances of the same type of resource to the existing resources, rather than increasing the capacity of the existing resources as in vertical scaling. For example, a number of additional processors, computing devices, and application instances, or the like, may be increased to thereby increase the performance of the overall system. Horizontal scaling has the advantage of being more fault tolerant and providing lower latency, but is more costly and difficult to implement than vertical scaling.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for routing transactions to backend application instances. The method comprises receiving a transaction from a source computing system, wherein the transaction comprises at least one identifier of a product or service associated with the transaction. The method also comprises performing a lookup operation in an in-memory database of transaction routing information, based on the at least one identifier. The transaction routing information maps the at least one identifier to a backend application instance identifier of a backend application instance. The method further comprises routing the transaction to the backend application instance based on the backend application instance identifier, processing, utilizing the backend application instance, the transaction to generate transaction results, and returning the transaction results to the source computing system.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating the primary operational components of a horizontal scaling and intelligent transaction routing system in accordance with one illustrative embodiment;

FIG. 3 is an example diagram illustrating an operation for performing a setup flow in accordance with one illustrative embodiment;

FIG. 4 is an example diagram illustrating an operation for performing an onboarding flow in accordance with one illustrative embodiment;

FIG. 5 is an example diagram illustrating an operation for performing a channel servicing transaction flow in accordance with one illustrative embodiment;

FIG. 6 is flowchart outlining an example operation for performing a setup flow in accordance with one illustrative embodiment;

FIG. 7 is flowchart outlining an example operation for performing an onboarding flow in accordance with one illustrative embodiment; and

FIG. 8 is flowchart outlining an example operation for performing a channel servicing transaction flow in accordance with one illustrative embodiment.

### DETAILED DESCRIPTION

Modernization of monolithic applications to solve performance or scalable issues requires a large amount of time and effort. Most monolithic applications can only be scaled vertically as these applications have a tightly coupled frontend user interface, backend (server side code), and database. As a result, it is not possible to scale one layer, or one service separately, and instead, the entire stack needs to be scaled. This is a very expensive undertaking, and sometimes is not possible because of architecture limitations. Moreover, even with vertical scaling of monolithic applications, there is always an upper bound on transaction processing or throughput, i.e., there is a technological and cost limit to the amount of resources that can be effectively added to a monolithic application, e.g., infrastructures only have so much bandwidth.

Hence, any scaling of a monolithic application requires a large amount of effort and resources to accomplish. For example, in order to ensure overall system interoperability, not only is an in-depth understanding of the application required, but decomposing the application and developing one or more new modules in order to implement mechanisms for addressing performance and scalability issues, also takes significant end-to-end effort with regard to development, integration, and testing. For legacy monolithic applications, which are developed in production operations over many years or even decades, it is often very difficult to identify the system analysts who can truly provide precise system and functional requirements or in-depth understanding of the legacy monolithic application. Alternatively, replacement of the monolithic application with a new set of products or services is very costly, high risk, and requires a mass product migration.

Thus, whether attempting to update the monolithic application to address performance and scalability issues, or replacing a monolithic application with a set of new products/services, a potential business interruption and huge investment of resources is required across the organization owning/providing the application. Having mechanisms that can provide a clear and practical approach to horizontally scale monolithic applications, and thereby increase the transaction processing capability of the monolithic application and resolve the performance issue, or even to introduce new products or computer functionality to address time-to-market issue, in a way that will minimize the impact to monolithic applications, channel applications, and interfacing applications, is of substantial benefit to a plethora of organizations.

The improved computing tool and improved computing tool operations/functionality of the illustrative embodiments are specifically directed to solving the technological problems associated with monolithic application scalability and performance issues. The improved computing tool and improved computing tool operations/functionality implement an intelligent routing capability that decouples the channel and interfacing applications from a backend, e.g., product processor, application allowing transactions to be routed based on predefined routing information. The mechanisms of the illustrative embodiments also reduce the time to market by allowing new products or services to be easily introduced with minimum or no impact on the channel and interfacing applications.

The illustrative embodiments provide a practical solution to address the monolithic application scalability problem by adding intelligent transaction routing computing tools and capabilities that allows transactions to be routed to the appropriate instance of the monolithic applications, leveraging unique identifiers, e.g., product identifier (id) or combination of product id and product code, or the like, which are predefined as part of transaction routing lookup services during the product initialization or setup process. This allows an additional instance of the monolithic application to be added as part of horizontal scalability. With this concept, a monolithic application is treated as a complex microservice that may be horizontally scaled such that multiple instances of the monolithic application may be provided and through the mechanisms of the illustrative embodiments, transaction routing is performed with regard to each of the multiple instances.

As noted above, the improved computing tool and improved computing tool operations/functionality provide mechanisms to capture specific transaction routing information as part of a product or service initialization or setup operation. Routing information can be formed, for example, from a unique identifier or set of identifiers, e.g., a product id or a unique combination of product id and product code, in association with an instance or system id of the monolithic application. The captured information can be derived and stored in a cache or in-memory database, creating a transaction routing lookup database with which a transaction routing lookup service may operate and can be leveraged by channel and interfacing applications once embedded as part of the enterprise application programming interface (API) integration services. Cache or in-memory database implementation may be used for implementation practicality, e.g., Remote Dictionary Service (Redis) can provide a very fast read access of less than 1 millisecond, and this cached or in-memory database may be used to provide a routing lookup service that can be implemented with minimum impact to the overall transaction processing and response time.

That is, the illustrative embodiments provide a digital onboarding platform that obtains the knowledge of which products and services belong to which backend application instances. For example, when a new product or service is to be setup with a cloud computing system or the like, the digital onboarding platform receives a request to setup the new product or service and associates, with the new product or service, one or more corresponding unique identifiers, e.g., product identifier (id) and/or product code. The product ID represents a unique technical ID of a specific product, which may serve as a primary key in a product table. The product code is a short code of the product, which may be a key-value pair, e.g., SA may be the product code of a “Savings Account” and the product ID may be 1101.

Mapping logic of the digital onboarding platform may operate to map the product/service with a backend application instance, where the backend system may host a plurality of instances of the same backend application, e.g., instances of a same monolithic application which, in accordance with the illustrative embodiments, is considered a large microservice. The mapping logic may make use of the assigned unique identifiers, e.g., product id and product code, and correlate them with a backend application instance identifier of the associated backend application instance.

The digital onboarding platform performs a new services/products subscription initialization operation, e.g., new account opening operation, via onboarding services of an enterprise API system, which registers the new services/products subscriptions with the associated relevant backend application instance of the application, e.g., an instance of a monolithic application. The onboarding platform is a frontend application that is used and interacted with by the users/customers to perform the onboarding operation, and has user interface and validation logic. The onboarding services are a backend service that actually processes transactions that users execute in the onboarding platform. The separation of fronted and backend components follows a microservices architecture.

The enterprise API system provides the logic, via the onboarding services and associated APIs, for routing the setup process logic to the correct backend application instance, e.g., product processors. It should be appreciated that a “product processor” is the processing system for a particular product, which is mainly a backend application which runs in a container orchestration platform, such as OpenShift or the like. For example, “Accounts-deposits” may be a product processor component which has services such as balance inquiry, debit credit invoice generation, fund transfer etc.

The backend application instance, e.g., product processor, performs the product/service initialization and setup via the onboard services of the enterprise API and, assuming that such initialization is successful, returns a successful result to the digital onboarding platform to thereby inform the digital onboarding platform of the successful setup of the product service. Once the subscription or setup process is completed, an event can be processed with event mesh logic. The event mesh logic provides an infrastructure for sending notifications to applications across a distributed environment, such as in the case of an event-driven computer system architecture, e.g., a cloud computing architecture or the like. Events inform the various applications, products, or services, of changes, actions, and observations occurring within the components of the computing system architecture via event notifications, such that the various components of the architecture may respond to the event if needed.

The event notification that may be sent to the event mesh logic may be an event published by the digital onboarding platform in response to the successful initialization/setup process of the new product/service, where the event notification may have a topic, for example, of a new service/product subscription and may specify the unique identifier(s), e.g., system id of the backend application instance, product identifier, product code, and the like. In some illustrative embodiments, the backend application instance, e.g., product processor, may publish the event notification to the event mesh logic rather than the digital onboard platform. This option may be utilized due to separation in layer architectures and not wanting to have all of the components tightly coupled.

In either case, the event mesh logic listens to published events and then calls the enterprise API system to generate an update to the in-memory or cached database for use in performing transaction routing lookup operations via lookup services. The event mesh logic is part of an event driven architecture that architects a loosely coupled system. While synchronous API calls would make the entire transaction thread coupled such that one process needs to wait for other processes to complete before proceeding, the event driven architecture having the event mesh logic decouples this waiting of processes. Thus, while another system is processing a transaction, the frontend does not need to wait and can serve other user/customer transactions.

The enterprise API processes the request from the event mesh logic and updates its in-memory or cached database of mappings between product identifiers, e.g., product code and/or product id, and backend application instance identifiers, e.g., system id. Once this process is completed, all the channel and interface applications of the enterprise API can call a lookup service via the enterprise API to process any received transaction. This can be done without requiring any knowledge of the background application instance by the product/service that is the source of the transaction.

In response to receiving such a transaction from a product/service, the lookup service of the enterprise API system performs a lookup operation in the in-memory or cached database for the backend application instance information that is associated with the unique identifier(s) of the product/service from which the transaction was received. Based on the retrieved backend application instance information, the enterprise API system routes the transaction to the appropriate backend application instance, e.g., product processor.

Thus, the illustrative embodiments provide an ability to predefine the routing logic in advance during the onboarding of the product/service initialization process. This allows additional instances of a monolithic application to be added in the backend system which increases the availability of application resources and thus, improves the scalability of the monolithic application horizontally. Through the event mesh, the illustrative embodiments allow real-time updates of the routing information directly to the in-memory or cached database associated with the lookup services of the enterprise API system. As a result, the routing information will be updated immediately following the setup process completion, for immediate use by the channel and interface applications of the enterprise API system. The illustrative embodiments decouple the channel and interface applications from the backend application instances. In this way, the illustrative embodiments do not cause an impact on the channels when scaling a new instance of an existing backend application, e.g., an existing legacy application, and provides only a minimum impact in the case of a new backend application providing new products or services. Thus, the illustrative embodiments offer an alternative to legacy application modernization to address time-to-market and performance issues by adding mechanisms to implement predefined routing information which allows the horizontal scaling of monolithic applications and/or adding a new instance of a new backend application, e.g., product processor, to provide new functions, products, or services.

The illustrative embodiments can be applied in real-world examples to address performance issues with regard to a plethora of different types of products/services and corresponding background applications. For example, core banking performance issues involving providing new products or services, or increasing the performance of existing products/services, may be addressed by the mechanisms of the illustrative embodiments without, or with minimum, impact to the channel servicing applications.

For example, the “core banking transformation” project is one of the most challenging and high-risk projects that require huge resources and effort to embark upon. This is potentially due to the complexity and long historical development of core banking applications over decades, and the fact that a failed project can often cause a substantial setback to the particular banking organization. In the modern era, where digital transformation and disruption are a norm for organization conduct, putting the organization substantial resources for both business and information technology on the core banking transformation project can cause the organization significant opportunity losses and increase the time to market. In addition, the complexity of the core banking transformation project will increase even more when the target core banking platform is a third generation cloud native solution. That is, cloud adoption of the third generation core banking adds more complexity to data migration, regulatory requirements, and data security measures, particularly on financially sensitive data. All these have added more complexity and made the core banking transformation project for the third generation solution nearly an impossible mission with existing monolithic application based architectures. The implementation of mechanisms of the illustrative embodiments permits a solution that makes such a core banking transformation project feasible, even with the third generation solution implementation.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a horizontal scaling and intelligent transaction routing system 200. The improved computing tool implements mechanism and functionality, such as generating mappings of products/services to backend application instances and using these mappings to automatically route transactions to the backend application instances, which cannot be practically performed by human beings either outside of, or with the assistance of, a technical environment, such as a mental process or the like. The improved computing tool provides a practical application of the methodology at least in that the improved computing tool is able to process transactions automatically by routing the transactions to backend application instances and thereby facilitate horizontal scaling of monolithic applications and legacy applications, thereby improving performance.

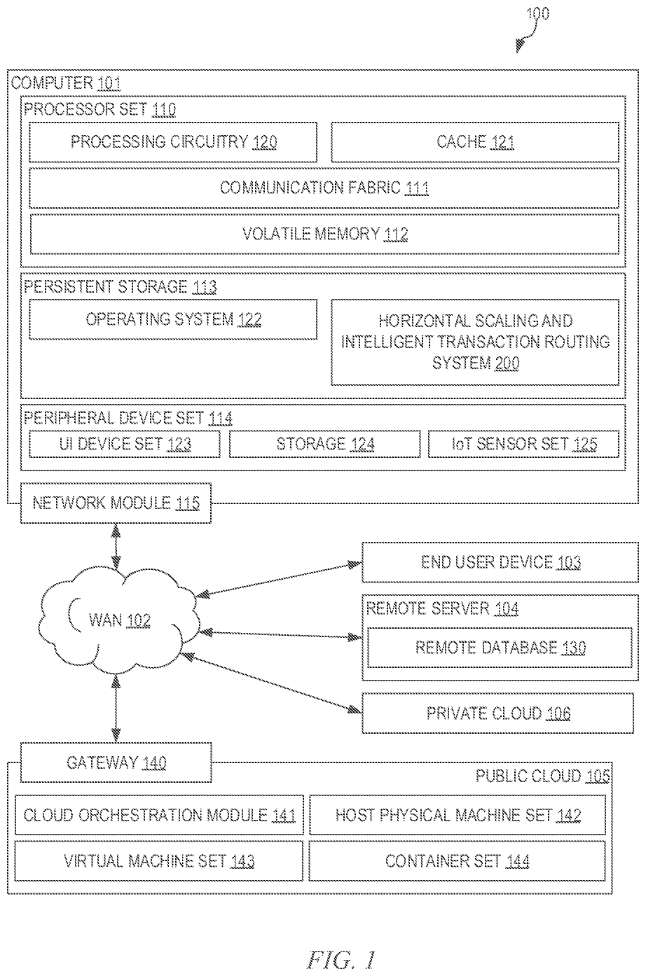

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as the horizontal scaling and intelligent transaction routing system 200. In addition to horizontal scaling and intelligent transaction routing system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and horizontal scaling and intelligent transaction routing system 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in horizontal scaling and intelligent transaction routing system 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in the horizontal scaling and intelligent transaction routing system 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a horizontal scaling and intelligent transaction routing system 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates horizontal scaling of monolithic and legacy applications via an automatic onboarding of products/services and intelligent routing of transactions between products/services and backend application instances.

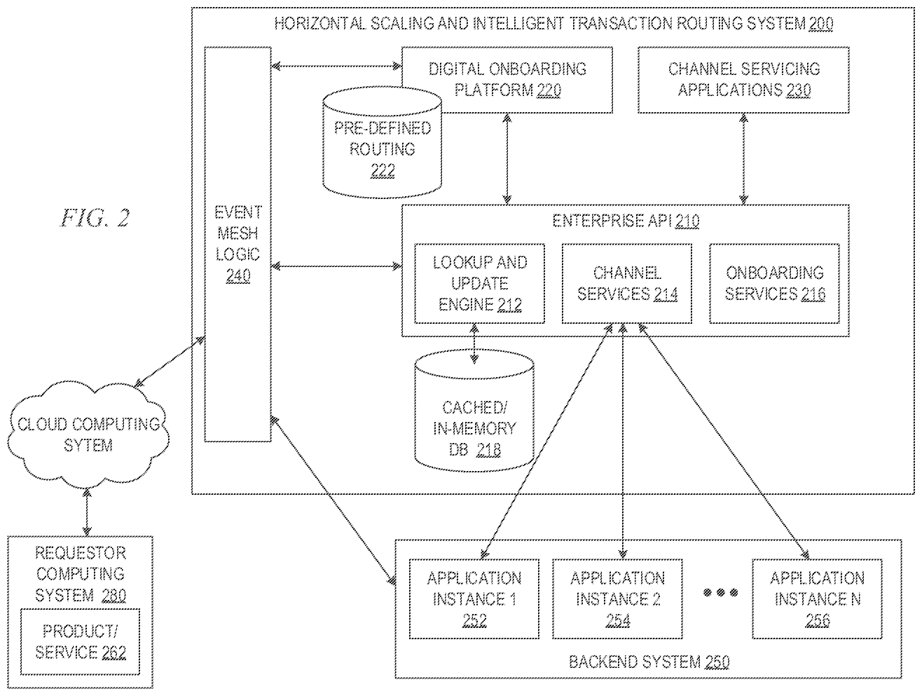

FIG. 2 is an example block diagram illustrating the primary operational components of a horizontal scaling and intelligent transaction routing system in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way in which application scaling is performed by providing horizontal scaling capabilities and intelligent transaction routing which cannot be practically performed by human beings as a mental process and is not directed to organizing any human activity.

As shown in FIG. 2, the horizontal scaling and intelligent transaction routing system 200 includes an enterprise API 210, digital onboarding platform 220, channel servicing applications 230, and event mesh 240. The horizontal scaling and intelligent transaction routing system 200 operates in conjunction with a backend system 250 in which a plurality of instances 252-256 of a monolithic application may be provided as part of a horizontal scaling of the monolithic application in accordance with the principles and mechanisms of the illustrative embodiments. The enterprise API 210 comprises a lookup and update engine 212, channel services 214, onboarding services 216, and a cached or in-memory database of transaction routing information 218. The digital onboarding platform 220 further comprises a database of pre-defined routing information 222.

The digital onboarding platform 220 comprises computer executed logic that obtains and maintains, in the database 222, pre-defined routing information for products and services associated with backend application instances. The pre-defined routing information is provided during application configuration and specifies which transactions for which user/customer set will go to which systems. This data will be defined based on a business and architecture process workshop and once all the parties agree, is configured into the routing information database which is then referenced during actual request routing.

That is, when a new product or service 262 is to be setup with a cloud computing system, and make use of resources of that cloud computing system to provide support for the product/service 262, the new product/service 262 setup request is posted as a new product/service event from the requestor computing system 260 to the event mesh 240 of the horizontal scaling and intelligent transaction routing system 200. The new product/service event causes a notification to be sent to the digital onboarding platform 220 which processes the notification from the event mesh 240 to setup the new product/service 262 and associates, with the new product/service 262, one or more corresponding unique identifiers, e.g., product identifier (id) and/or product code.

The digital onboarding platform 220 may comprise mapping logic (not shown) which operates to map the product/service 262 with a backend application instance 252-256, e.g., mapping product id/product code to a system id of a backend instances 252-256 of a monolithic application. The pre-defined mappings of product id/product code to system id of a backend instance 252, 254, 256 may be used to provide an initial populating of the cached or in-memory database 218 of the enterprise API 210, for example. The cached or in-memory database 218 stores the mappings as transaction routing information for later use in performing lookups and updating of transaction routing information to ensure proper routing of transactions to corresponding instances 252-256 of monolithic applications in the backend system 250.

The backend system 250 may host a plurality of instances 252-254 of the same backend monolithic application. When the monolithic application performance is not sufficient to maintain or provide required levels of performance for one or more products/services, e.g., product/service 262, additional instances of the monolithic application may be spawned in the backend system 250 and corresponding transaction routing information may be used to update or generate mappings in the cached or in-memory database 218, e.g., if the product/service 262 is first associated with an instance 252 of the monolithic application, and performance is lacking as more workload is sent to the product/service 262, then additional instance 254 of the monolithic application may be generated and corresponding transaction routing information added to the cached or in-memory database 218 to route transactions to both instances 252 and 254 of the monolithic application in accordance with a routing policy, e.g., load balancing policy or the like.

In accordance with the illustrative embodiments, monolithic applications are considered a type of large microservice and thus, are able to be instantiated in a dynamic manner as performance requires. The mechanisms of the illustrative embodiments provide improved computing tools and improved computing tool operations/functionality for performing such instantiation and providing intelligent transaction routing to the various instances 252-256 of the monolithic application to ensure that required performance of the monolithic application is provided.

The mapping logic of the digital onboarding platform 220 may make use of the assigned unique identifiers, e.g., product id and product code, and correlate them with a backend application instance identifier, e.g., system id, of the associated backend application instance 252-256. The lookup and update engine 212 of the enterprise API 210 may perform lookup operations to find transaction routing information in the cached or in-memory database 218 and route transactions to appropriate instances 252-256 of the monolithic application based on these identifier mappings, and may further include similar mapping logic to that of the digital onboarding platform 220 for updating the mappings of the transaction routing information in the cached or in-memory database 218 when new instances of the monolithic application are spawned.

As mentioned above, when a new product/service is first registered with the cloud computing system with which the horizontal scaling and intelligent transaction routing system 200 is associated, the digital onboarding platform 220 performs a new services/products subscription initialization operation, e.g., new account opening operation, as part of processing the new product/service event notification, via digital onboarding platform 220 (frontend) and the onboarding services 216 (backend) of the enterprise API 210. The onboarding services 216, invoked by the digital onboarding platform 220, registers the new services/products subscriptions with the associated relevant backend application instance 252-256 of the application, e.g., an instance of a monolithic application. The enterprise API system 210 provides the logic, via the onboarding services 216 and associated APIs, for determining a routing of the setup process logic to the correct backend application instance 252-256, e.g., product processors. For example, during business workshops it is determined which backend systems are able to onboard which products or services and what types of data/parameters are required. As an example, consider a backend instance of “product-account-opening” which is responsible for performing the new accounts opening operations, and this instance requires that X & Y data be passed to it. After such a determination is made during business workshops, initial routing logic can be setup, either in the configuration files of the onboarding services, or loading in the in-memory database when the onboarding services are started the very first time. At this time, the in-memory database/cache has initial routing details, e.g., for “account opening” which backend is to be called.

The backend application instance 252-256, e.g., product processor, performs the product/service initialization and setup via the onboarding services 216 of the enterprise APIs 210 which perform the initial routing setup. Assuming that such initialization is successful, a successful result is returned to the digital onboarding platform 220 to thereby inform the digital onboarding platform 220 of the successful setup of the product/service 262. Once the subscription or setup process is completed, an event can be processed with event mesh logic 240. As noted above, the event mesh logic 240 provides an infrastructure for sending notifications to applications across a distributed environment, e.g., a cloud computing system, or the like. The events inform the various applications, products, or services, of changes, actions, and observations occurring within the components of the computing system architecture via event notifications, such that the various components of the architecture may respond to the event if needed.

The event notification that may be sent to the event mesh logic 240 may be an event published by the digital onboarding platform 220 in response to the successful initialization/setup process of the new product/service 262, where the event notification may have a topic, for example, of a new service/product subscription and may specify the unique identifier(s), e.g., system id of the backend application instance 252, 254, or 256, product identifier associated with the new product/service 262, product code associated with the new product/service 262, and the like. In some illustrative embodiments, the backend application instance 252, 254, or 256 may publish the event notification to the event mesh logic 240 rather than the digital onboard platform 220.

The event mesh logic 240 listens to published events and then calls the enterprise API system 210 to generate an update to the in-memory or cached database 218 for use in performing transaction routing lookup operations via lookup and update engine 212. That is, for an event that indicates a new product/service has been successfully registered with a backend instance 252-254, the lookup and update engine 212 of the enterprise API system 210 processes the event notification from the event mesh logic 240 and updates its in-memory or cached database 218 of mappings between product identifiers, e.g., product code and/or product id, and backend application instance 252-256 identifiers, e.g., system id. Once this process is completed, all the channel and interface applications 230, via the channel services 214 of the enterprise API 210, can call a lookup service of the lookup and update engine 212 to process any received transaction from the product/service 262 to identify the backend instance(s) 252-256 associated with the product id/product code of the product/service 262 and thereby route the transaction to the associated backend instance 252-256 of the monolithic application.

In response to receiving a transaction from a product/service 262, the lookup service in the lookup and update engine 212 of the enterprise API system 210 performs a lookup operation in the in-memory or cached database 218 for the backend application instance 252-256 information that is associated with the unique identifier(s) of the product/service from which the transaction was received. Based on the retrieved backend application instance information, the enterprise API system 210, via the channel services 214, routes the transaction to the appropriate backend application instance 252-256, e.g., product processor.

That is, the channel servicing applications 230 send request messages to channel services 214 via the enterprise API system 210. The request message includes either a unique combination of a product code and/or a unique product/service/account id. Based on the information provided to the channel services 214, the channel services 214 call the lookup services 212 to determine the appropriate backend application instance 252-256. The channel services 214 will, if required, transform the request message and then forward the request message to the appropriate backend application instance 252-256. The backend application instance (e.g., product processor) 252-256 processes the transaction request and then returns the result. The channel services 214 will return results back to channel servicing applications 230 via the enterprise API system 210.

It should be appreciated that the routing of transactions to application instances 252-256 can be done without requiring that the product/service 262, which is the source of the transaction, have any knowledge of the background application instances 252-256 themselves. Thus, the product/service 262 is effectively decoupled from the backend monolithic application instances 252-256 and can send transactions to the cloud computing system and have them automatically routed to the correct application instances 252-256, as well as have automatic horizontal scaling of the monolithic application instances as performance requirements indicate the need for more instances of the monolithic application. That is, the illustrative embodiments support on-demand addition of new application backend instances to support new channels and to divert traffic to new backend application instances, e.g., new product processors, in order to implement horizontal scaling of monolithic applications. The illustrative embodiment utilize the enterprise API system 210 layer which seamlessly forwards requests to appropriate backend instances and distributes traffic to multiple instances (new or old) achieving scalability.

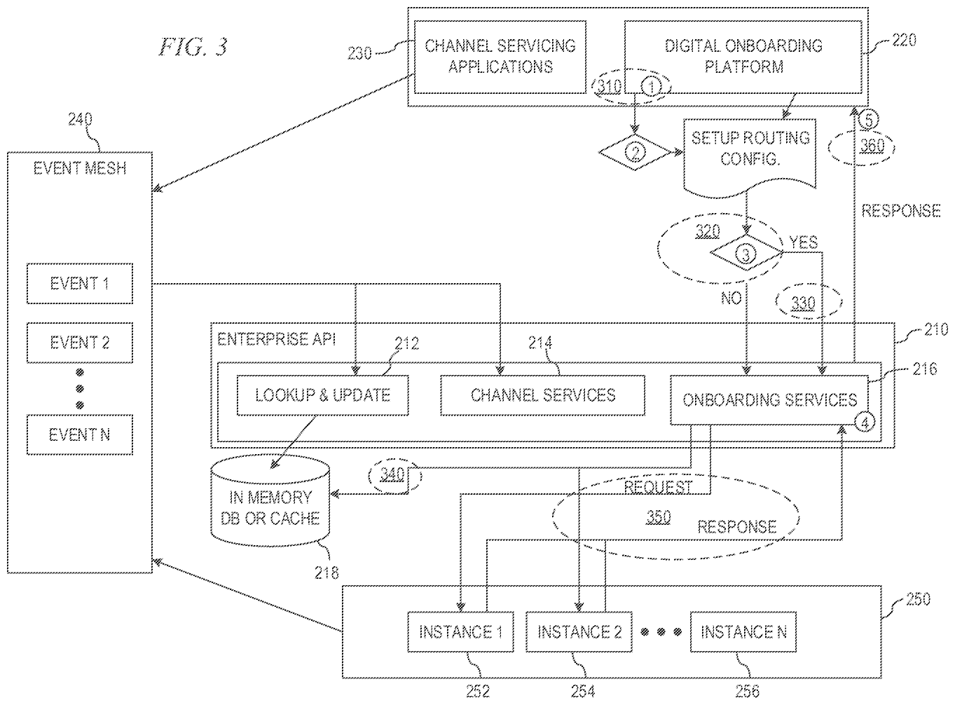

FIG. 3 is an example diagram illustrating an operation for performing a setup flow in accordance with one illustrative embodiment. Elements in FIG. 3 that are similar to the corresponding elements in FIG. 2 are shown with similar reference numerals.

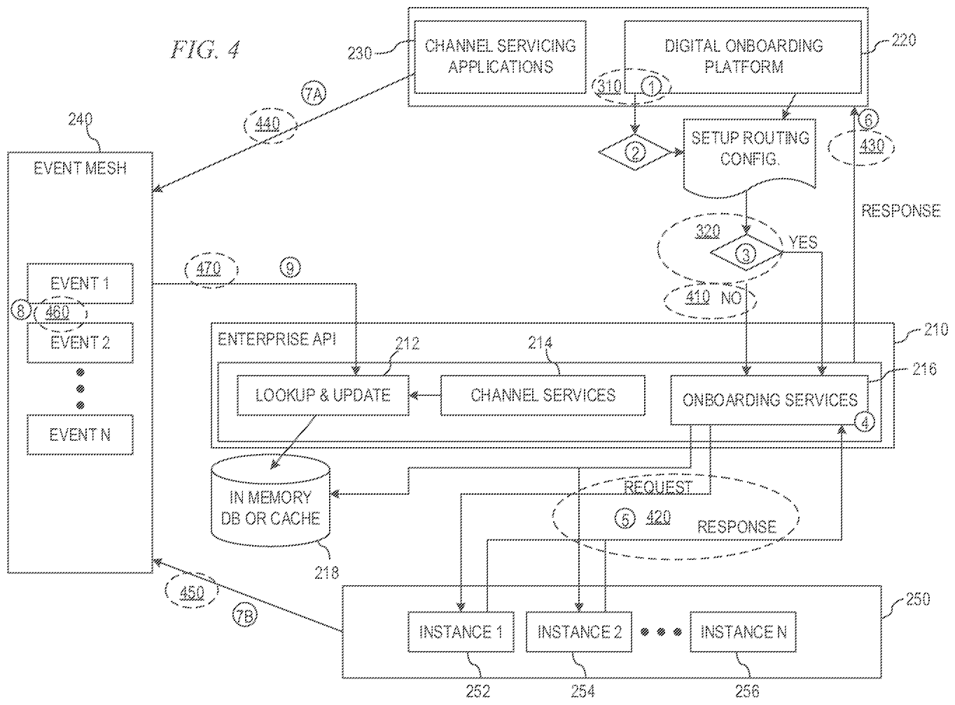

As shown in FIG. 3, at initial setup of a product/service, the digital onboarding platform 220 performs an initialization process to predefine the routing for the product/service subscription/setup transaction (310). This process may include checking that, when the system is started the very first time, an initialization process predefines the routing for the product subscription/setup transaction, and then on subsequent starts the system routes requests to the onboarding services of the enterprise API system. In some illustrative embodiments, the onboarding service uses the service/product subscription and product code to lookup and determine the appropriate backend application instance based on the predefined routing information. Thus, as part of the initialization process, the digital onboarding platform 220 checks to determine if this is an initial setup of the product/service (320). For example, in some illustrative embodiments, there is configuration parameter setup which tells that specifies whether this is a first time start or a subsequent start. The value of this configuration parameter (true/false or yes/no) can be stored in various mediums, such as a file system, in-memory database, security wallet, or the like. If it is determined that this is an initial setup, the request to setup the product/service subscription is routed to the onboarding services 216 of the enterprise API 210 (330). It should be noted that if this determination indicates that this is not an initial setup, the onboarding process shown in FIG. 4 is followed, as described hereafter.

The onboarding service 216 then calls the lookup and update engine 212 to update the predefined routing information in cached or in-memory database 218, where this routing information will include service/product subscription, system/instance id, and product id and/or product code (340). The onboarding services 216 uses this information to determine the routing required as part of the product subscription/setup transaction. In addition, the onboarding services 216 may send onboarding requests to one or more of the instances 252-256 of the monolithic application (e.g., product processors) to have these instances 252-256 perform the onboarding process based on the required parameter data sent by the onboarding services 216 (350). That is, the onboarding services 216 sends the onboarding requests to backend instances (product processors) 252-256 by first identifying which backend instance(s) 252-256 to send the onboarding request(s), and then preparing the required parameters (data) to send as part of the onboarding request(s) to the backend instance(s) 252-256. In return, the backend instance(s) 252-256 will confirm the successful onboarding or failure of the request with appropriate messages and status codes.

The onboarding service 216 returns the result for the initial setup to the digital onboarding platform 220 (360). The initial request is for the initial first-time setup only to the onboarding services to perform the initial lookup setup. Then based on the API call results, the digital onboarding platform determines either a success or failure of the initial setup and then updates the initial setup configuration parameter. Having returned the results to the digital onboarding platform 220, the initial setup of the product/service is completed and the cached or in-memory database 218 now stores the initial predetermined transaction routing information for mapping the product/service identifiers, e.g., product id/product code, with the backend application instance identifier, e.g., system id, such that subsequent transactions from the product/service may be appropriately routed to application instances 252-256 in accordance with the cached or in-memory database stored transaction routing information.

FIG. 4 is an example diagram illustrating an operation for performing an onboarding flow in accordance with one illustrative embodiment. Again, elements in FIG. 4 that are similar to the corresponding elements in FIGS. 2 and 3 are shown with similar reference numerals. It should be noted that in FIG. 3, the operations are being performed during an initial pre-routing setup. In FIG. 4, the backend application performing the product/setup initialization and setup is the actual onboarding of the products/services and not performing pre-routing setup. That is, in FIG. 4, the backend applications/instances are responsible for performing the actual onboarding/registration of products and services with the backend application instances. They receive requests from the onboarding services during initial setup and receive requests from channel services in the subsequent requests. The input requests contain unique service/product description data, system/instance identifiers, and product codes.

As shown in FIG. 4, in order to perform the onboarding of a new product/service, the digital onboarding platform 220, similar to the operation in FIG. 3, performs an initialization process to predefine the routing for the product/service subscription/setup transaction (310) and, as part of this process, determines if this is the initial setup (320). However, in the onboarding operation shown in FIG. 4, the determination results in a determination that this is not the initial setup of the product/service, i.e., the determination is “No” in 320. In the case that the determination is that this is not an initial setup of the product/service, then the request is sent to the onboarding services 216 of the enterprise API 210 which, rather than perform the initial setup of the product/service, instead performs a lookup of the product/service subscription information, e.g., product id, product code, or the like, to identify the mapping of the product/service to the backend application instance 252-256, e.g., system id, via the transaction routing information stored in the cached or in-memory database 218 (410).

Based on the transaction routing information, the onboarding services 216 perform operations with the backend application instance 252, 254, and/or 256, e.g., the product processors, to perform a product/service initialization and setup with the backend application instance(s) 252, 254, and/or 256 (420). The backend instances receive requests from the onboarding services 216 during initial setup and receive requests from channel services 230 in the subsequent requests. The input requests contain unique service/product subscription data, system/instance id, and product code. The backend instances are responsible to onboard the actual product or service in the system. Once onboarding/registration is successful or failed then it returns response back with error message and status code.

Once the setup with the backend instances is completed, the onboarding services 216 returns a successful result to the digital onboarding platform (430). The digital onboarding platform 220 initiates the initial route configuration setup request and the digital onboarding platform 220 expects a response which confirms that the initial setup is done and that the in-memory database/cache contains the initial route configuration. Once the digital onboarding platform 220 receives a successful response, then the digital onboarding platform 220 will update the configuration parameter so that next time it should not start the initial setup request again.

Once the subscription or setup process is successfully completed, there are two options for posting an event to the event mesh logic 240 for processing by other applications. In a first option, the digital onboarding platform 220 publishes the event to the event mesh logic 240 (440). For example, this event may be an event data structure specifying a topic of new service/product subscription, system/instance id, product code, and product/service/account id. In a second option, the corresponding application instance 252, 254, or 256 (e.g., product processor) can publish the event to the event mesh logic 240. In the backend system 250 publishes the event to the event mesh logic 240 (450), again with the event having a topic of the type New service/product subscription, system/instance id, product code, and product/service/account id in one example implementation.

The event mesh logic 240 listens for published events and thus, when the digital onboarding platform 220 or backend system 250 publishes the event indicating that the setup of the product/services with the backend application instance as successfully completed, the event mesh logic 240 retrieves the message and then derives the inputs required to call the enterprise API 210 (460). The event mesh logic 240 then calls the enterprise API (470) to generate the update to the cached or in-memory database 218 of transaction routing information for future use by the lookup services of the lookup and update engine 212.

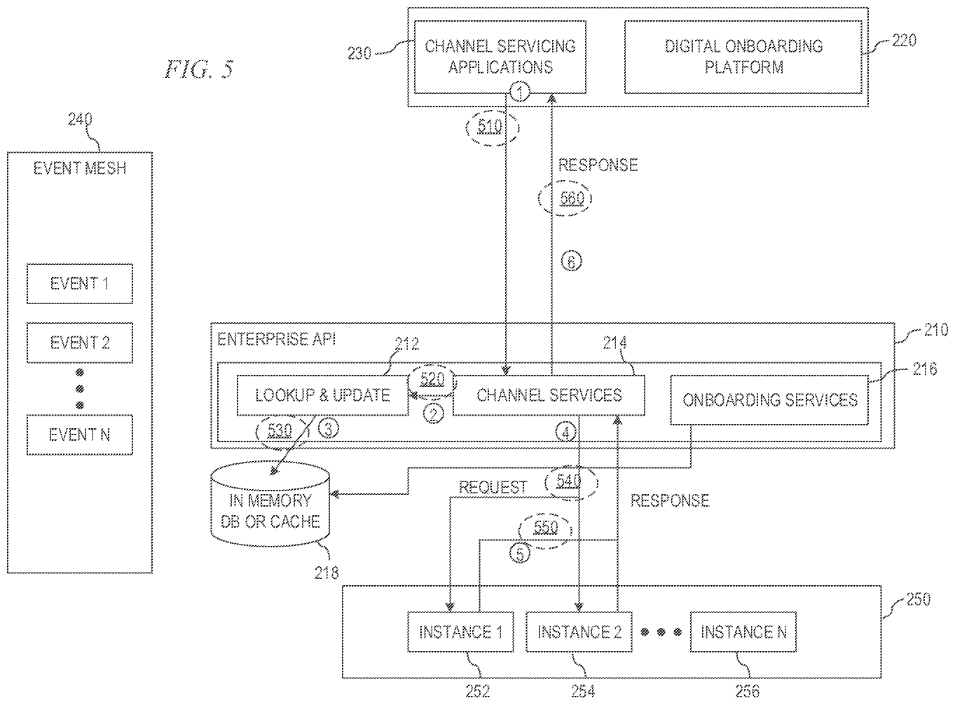

FIG. 5 is an example diagram illustrating an operation for performing a channel servicing transaction flow in accordance with one illustrative embodiment. As with the other diagrams in FIGS. 3-4, similar elements are represented with similar reference numerals. The operation outlined in FIG. 5 may be initiated, for example, when an end user is uses a channel servicing application and initiates an action, such as opening a new account, subscribing to a service, such as a funds transfer service, or the like. Once a user takes an action, the channel servicing application sends the end user request to the channel services via the enterprise API and then the described functionalities/processes are performed.

As shown in FIG. 5, as part of the processing of a transaction, the channel servicing applications 230 send requests to channel services 214 of the enterprise API 210 (510). The request message includes one or more identifiers of a product/service for which the transaction is to be processed, i.e., the source of the transaction. These one or more identifiers may include, for example, a product code and/or a unique product/service/account id. Based on the identifier information provided, the channel services 214, via the lookup services of the lookup and update engine 212, initiates a lookup operation to determine the appropriate backend application instance 252, 254, or 256 to which to route the transaction for processing (520).

The lookup services of the lookup and update engine 212 of the enterprise API 210 performs a lookup operation in the cached or in-memory database 218 based on the identifier information from the request message and obtains the transaction routing information for one or more corresponding backend application instances 252-256 to which to route the transaction (530). This information is provided to the channel services 214 which then, if needed, transform the request message, i.e., converts data into a different format, for example, such as by adding/removing masking characters, formatting dates/times, etc., and then forwards the request message, or transformed request message, to the appropriate backend application instance 252-256 based on the transaction routing information retrieved (540). If there is no matching transaction routing information, the channel services will return an error code and status code to the channel servicing applications which use the error code for the product/operations team to investigate and trigger a product/service registration operation by manually triggering or pushing the event to event mesh logic with appropriate data in order to register the missing product/service in the in-memory database/cache of transaction routing information.

The backend application instance (e.g., product processor) 252, 254, or 256 processes the transaction, i.e., the request message or transformed request message, and then returns the result of the processing to the channel services 214 (550). The channel services 214 then returns the result back to the channel servicing application 230 (560). Once the onboarding request is successfully completed, the the channel services will return a successful response back to the channel servicing application(s). The channel servicing application(s) display results to the end-user so that the end-user understands that new product/service subscription registration has been done successfully. For example, if the end-user subscribes for a new account opening, once the registration is successful, the user can use the new accounts to carry out other financial transactions.

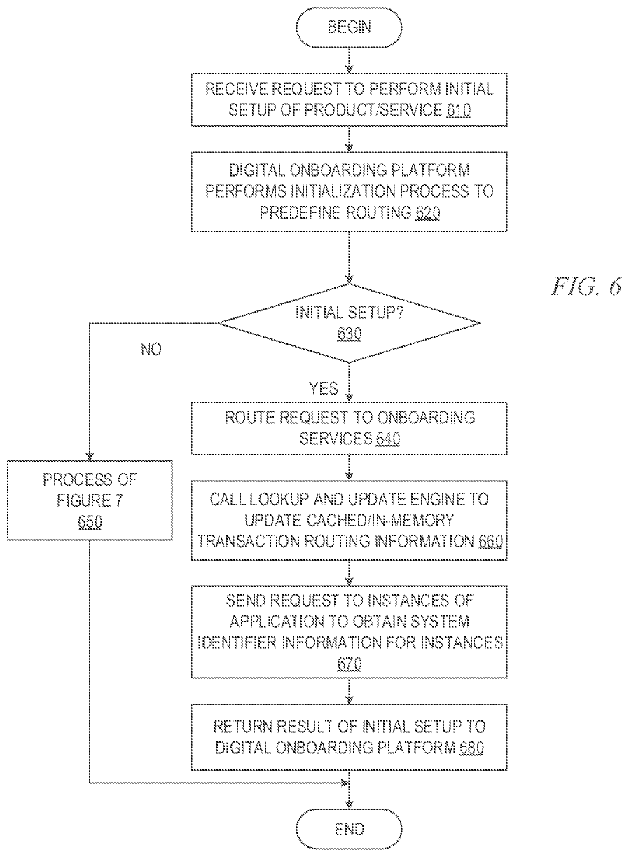

FIGS. 6-8 present flowcharts outlining example operations of elements of the present invention with regard to one or more illustrative embodiments. It should be appreciated that the operations outlined in FIGS. 6-8 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 6-8, and may, in some cases, make use of the results generated as a consequence of the operations set forth in FIGS. 6-8, the operations in FIGS. 6-8 themselves are specifically performed by the improved computing tool in an automated manner.

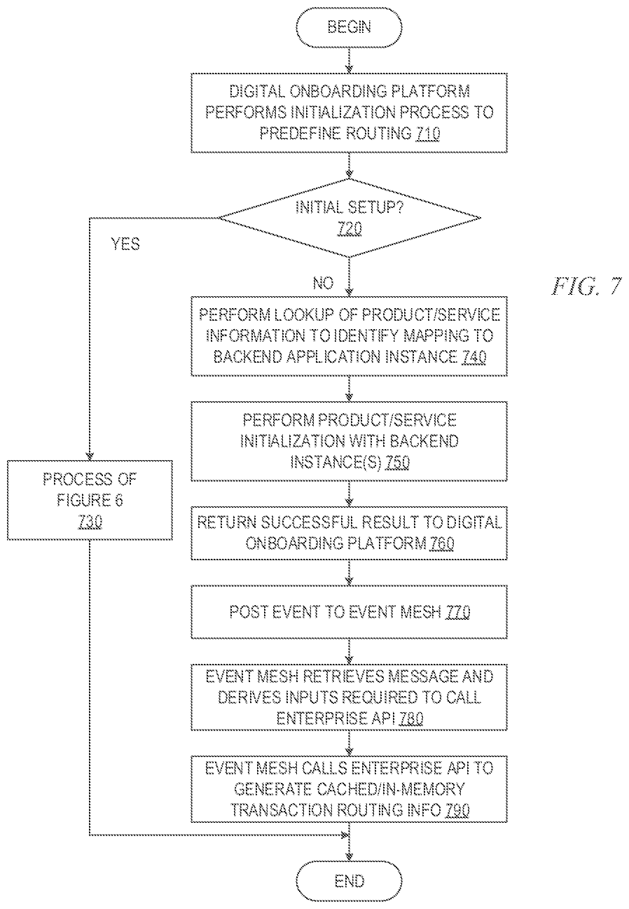

FIG. 6 is flowchart outlining an example operation for performing a setup flow in accordance with one illustrative embodiment. As shown in FIG. 6, the operation starts with a request being received to perform an initial setup of a product/service via the digital onboarding platform (step 610). The digital onboarding platform performs an initialization process to predefine the routing for the product/service subscription/setup transaction (step 620). As part of this process, the digital onboarding platform checks to determine if this is an initial setup of the product/service (step 630). If it is determined that this is an initial setup, the request to setup the product/service subscription is routed to the onboarding services of the enterprise API 210 (step 640). It should be noted that if this determination indicates that this is not an initial setup, the onboarding process shown in FIG. 7 is followed (step 650).

The onboarding service then calls the lookup and update engine to update the predefined routing information in the cached or in-memory database of transaction routing information (step 660). In addition, the onboarding services send a request to one or more of the instances of the monolithic application to obtain system identifier information for those instances (step 670), which return their system identifiers in a response to the onboarding services which uses this information to generate the predefined transaction routing information in the cached or in-memory database. The onboarding service then returns the result for the initial setup to the digital onboarding platform (step 680). Having returned the results to the digital onboarding platform, the initial setup of the product/service is completed and the cached or in-memory database now stores the initial predetermined transaction routing information for mapping the product/service identifiers, e.g., product id/product code, with the backend application instance identifier, e.g., system id, such that subsequent transactions from the product/service may be appropriately routed to application instances in accordance with the cached or in-memory database stored transaction routing information. The operation then terminates.

FIG. 7 is flowchart outlining an example operation for performing an onboarding flow in accordance with one illustrative embodiment. As shown in FIG. 7, in order to perform the onboarding of a new product/service, the digital onboarding platform, similar to the operation in FIG. 6, performs an initialization process to predefine the routing for the product/service subscription/setup transaction (step 710) and, as part of this process, determines if this is the initial setup (step 720). However, in the onboarding operation shown in FIG. 7, the determination results in a determination that this is not the initial setup of the product/service, i.e., the determination is “No” in step 720. If this were the initial setup of the product/service, then the process previously described with regard to FIG. 6 would be followed (step 730).

In the case that the determination is that this is not an initial setup of the product/service, then the request is sent to the onboarding services of the enterprise API which, rather than perform the initial setup of the product/service, instead performs a lookup of the product/service subscription information, e.g., product id, product code, or the like, to identify the mapping of the product/service to the backend application instance, e.g., system id, via the transaction routing information stored in the cached or in-memory database (step 740). Based on the transaction routing information, the onboarding services perform operations with the backend application instances, e.g., the product processors, to perform a product/service initialization and setup with the backend application instance(s) (step 750). Once the setup with the backend instances is completed, the onboarding services returns a successful result to the digital onboarding platform (step 760).

Once the subscription or setup process is successfully completed, there are two options for posting an event to the event mesh logic for processing by other applications (step 770). In a first option, the digital onboarding platform publishes the event to the event mesh logic. In a second option, the corresponding application instance (e.g., product processor) publishes the event to the event mesh logic.

The event mesh logic listens for published events and thus, when the digital onboarding platform or backend system publishes the event indicating that the setup of the product/services with the backend application instance as successfully completed, the event mesh logic retrieves the message and then derives the inputs require to call the enterprise API 210 (step 780). The event mesh logic then calls the enterprise API (step 790) to generate the update to the cached or in-memory database of transaction routing information for future use by the lookup services of the lookup and update engine. The operation then terminates.

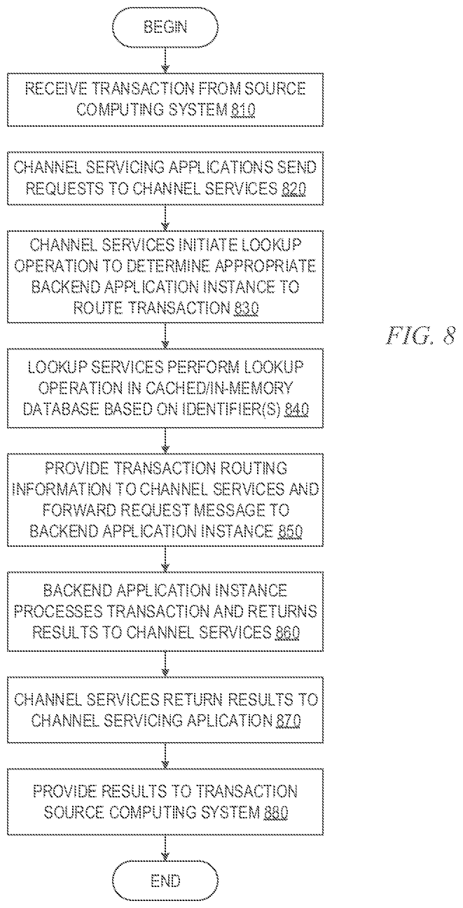

FIG. 8 is flowchart outlining an example operation for performing a channel servicing transaction flow in accordance with one illustrative embodiment. As shown in FIG. 8, the operation is initiated in response to receiving a transaction from a source computing system, such as from a product/service of a source computing system (step 810). As part of the processing of the transaction, channel servicing applications send requests to channel services of the enterprise API (step 820), where the request messages include one or more identifiers of a product/service for which the transaction is to be processed, i.e., the source of the transaction. These one or more identifiers may include, for example, a product code and/or a unique product/service/account id. Based on the identifier information provided, the channel services, via the lookup services of the lookup and update engine, initiates a lookup operation to determine the appropriate backend application instance to which to route the transaction for processing (step 830).

The lookup services of the lookup and update engine of the enterprise API performs a lookup operation in the cached or in-memory database based on the identifier information from the request message and obtains the transaction routing information for one or more corresponding backend application instances to which to route the transaction (step 840). This information is provided to the channel services which then, if needed, transform the request message and forward the request message, or transformed request message, to the appropriate backend application instance based on the transaction routing information retrieved (step 850).

The backend application instance (e.g., product processor) processes the transaction, i.e., the request message or transformed request message, and then returns the result of the processing to the channel services (step 860). The channel services then returns the result back to the channel servicing application (step 870) which provides the results to the transaction source (step 880). The operation then terminates.

Thus, the illustrative embodiments provide mechanisms for decoupling products/services from backend monolithic applications and providing a horizontal scaling capability for such monolithic applications. The mechanisms of the illustrative embodiments treat the monolithic applications as large complex microservices which can be instantiated in the backend system. Automated mechanisms for determining the transaction routing information, e.g., the mapping of product/service identifiers with application instance identifiers, are provided so as to allow the product/service to submit transactions without having to have a detailed knowledge of the implementation of application instances at the backend system. The enterprise API provides the services and logic for performing onboarding of products/services, generation and maintaining a cached or in-memory database of transaction routing information, and logic for routing transactions via channel services, such that transactions are appropriately routed from channel servicing applications to backend application instances. As a result, scaling of monolithic applications horizontally, rather than being limited to vertical scaling, is achieved.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for routing transactions to backend application instances, the method comprising:
receiving a transaction from a source computing system, wherein the transaction comprises at least one identifier of a product or service associated with the transaction;
performing a lookup operation in an in-memory database of transaction routing information, based on the at least one identifier, wherein the transaction routing information maps the at least one identifier to a backend application instance identifier of a backend application instance;
routing the transaction to the backend application instance based on the backend application instance identifier;
processing, utilizing the backend application instance, the transaction to generate transaction results; and
returning the transaction results to the source computing system.

2. The method of claim 1, wherein the backend application instance is one of a plurality of backend application instances for a same backend application, and wherein the transaction routing information maps the at least one identifier to one backend application instance in the plurality of backend application instances, each backend application instance in the plurality of backend application instances having a different backend application instance identifier.

3. The method of claim 2, wherein the backend application is a monolithic application, and wherein the plurality of backend application instances are copies of the monolithic application in a backend component separate from an enterprise application programming interface (API) implementing a lookup service to perform the lookup operation, which are part of a frontend component.

4. The method of claim 1, wherein the at least one identifier for the product or service is registered with an enterprise application programming interface (API) during a digital onboarding of the product or service, by a digital onboarding platform, and stored in the transaction routing information of the in-memory database.

5. The method of claim 4, wherein at least one of the digital onboarding platform or the backend application instance, in response to successfully registering the product or service with the enterprise API during the digital onboarding, sends an event to an event mesh, wherein the event specifies the at least one identifier and the backend application instance identifier, and wherein the event mesh calls the enterprise API, in response to the event, to update the in-memory database of transaction routing information based on the at least one identifier and backend application instance identifier.

6. The method of claim 5, wherein the registration of the product or service with the enterprise API, sending of the event to the event mesh, calling of the enterprise API to update the in-memory database of transaction routing information are performed in real-time such that the updated in-memory database of transaction routing information is available for immediate use by channel and interface applications of the enterprise API.

7. The method of claim 1, wherein the at least one identifier comprises at least one of a product identifier or a product code.

8. A computer program product comprising a computer readable storage medium having a computer readable program stored therein, wherein the computer readable program, when executed on a computing device, causes the computing device to:
receive a transaction from a source computing system, wherein the transaction comprises at least one identifier of a product or service associated with the transaction;
perform a lookup operation in an in-memory database of transaction routing information, based on the at least one identifier, wherein the transaction routing information maps the at least one identifier to a backend application instance identifier of a backend application instance;
route the transaction to the backend application instance based on the backend application instance identifier;
process, utilizing the backend application instance, the transaction to generate transaction results; and
return the transaction results to the source computing system.

9. The computer program product of claim 8, wherein the backend application instance is one of a plurality of backend application instances for a same backend application, and wherein the transaction routing information maps the at least one identifier to one backend application instance in the plurality of backend application instances, each backend application instance in the plurality of backend application instances having a different backend application instance identifier.

10. The computer program product of claim 9, wherein the backend application is a monolithic application, and wherein the plurality of backend application instances are copies of the monolithic application in a backend component separate from an enterprise application programming interface (API) implementing a lookup service to perform the lookup operation, which are part of a frontend component.

11. The computer program product of claim 8, wherein the at least one identifier for the product or service is registered with an enterprise application programming interface (API) during a digital onboarding of the product or service, by a digital onboarding platform, and stored in the transaction routing information of the in-memory database.

12. The computer program product of claim 11, wherein at least one of the digital onboarding platform or the backend application instance, in response to successfully registering the product or service with the enterprise API during the digital onboarding, sends an event to an event mesh, wherein the event specifies the at least one identifier and the backend application instance identifier, and wherein the event mesh calls the enterprise API, in response to the event, to update the in-memory database of transaction routing information based on the at least one identifier and backend application instance identifier.

13. The computer program product of claim 12, wherein the registration of the product or service with the enterprise API, sending of the event to the event mesh, calling of the enterprise API to update the in-memory database of transaction routing information are performed in real-time such that the updated in-memory database of transaction routing information is available for immediate use by channel and interface applications of the enterprise API.

14. The computer program product of claim 8, wherein the at least one identifier comprises at least one of a product identifier or a product code.

15. An apparatus comprising:
at least one processor; and
at least one memory coupled to the at least one processor, wherein the at least one memory comprises instructions which, when executed by the at least one processor, cause the at least one processor to:
receive a transaction from a source computing system, wherein the transaction comprises at least one identifier of a product or service associated with the transaction;
perform a lookup operation in an in-memory database of transaction routing information, based on the at least one identifier, wherein the transaction routing information maps the at least one identifier to a backend application instance identifier of a backend application instance;
route the transaction to the backend application instance based on the backend application instance identifier;
process, utilizing the backend application instance, the transaction to generate transaction results; and
return the transaction results to the source computing system.

16. The apparatus of claim 15, wherein the backend application instance is one of a plurality of backend application instances for a same backend application, and wherein the transaction routing information maps the at least one identifier to one backend application instance in the plurality of backend application instances, each backend application instance in the plurality of backend application instances having a different backend application instance identifier.

17. The apparatus of claim 16, wherein the backend application is a monolithic application, and wherein the plurality of backend application instances are copies of the monolithic application in a backend component separate from an enterprise application programming interface (API) implementing a lookup service to perform the lookup operation, which are part of a frontend component.

18. The apparatus of claim 15, wherein the at least one identifier for the product or service is registered with an enterprise application programming interface (API) during a digital onboarding of the product or service, by a digital onboarding platform, and stored in the transaction routing information of the in-memory database.

19. The apparatus of claim 18, wherein at least one of the digital onboarding platform or the backend application instance, in response to successfully registering the product or service with the enterprise API during the digital onboarding, sends an event to an event mesh, wherein the event specifies the at least one identifier and the backend application instance identifier, and wherein the event mesh calls the enterprise API, in response to the event, to update the in-memory database of transaction routing information based on the at least one identifier and backend application instance identifier.

20. The apparatus of claim 19, wherein the registration of the product or service with the enterprise API, sending of the event to the event mesh, calling of the enterprise API to update the in-memory database of transaction routing information are performed in real-time such that the updated in-memory database of transaction routing information is available for immediate use by channel and interface applications of the enterprise API.
